(19) United States
(12) Patent Application Publication
(10) Pub. No.: US 2007/0251971 A1
(43) Pub. Date: Nov. 1, 2007

(54) Nailing Machine and Magazine of Nailing Machine

(75) Inventors: Tatsushi Ogawa, Tokyo (JP); Yoshihiko Kondo, Tokyo (JP)

Correspondence Address: DRINKER BIDDLE & REATH (DC), 1500 K STREET, N.W., SUITE 1100, WASHINGTON, DC, 20005-1209, US

(73) Assignee: MAX CO., LTD., CHUO-KU, TOKYO (JP)

(21) Appl. No.: 11/666,501

(22) PCT Filed: Oct. 19, 2005
(86) PCT No.: PCT/JP05/19201

§ 371 Date: Apr. 27, 2007

(30) Foreign Application Priority Data
Oct. 28, 2004 (JP) 2004-313823

(51) Int. Cl. B27F 7/00

(52) U.S. Cl. 227/127

(57) ABSTRACT

A magazine 5 is structured by a magazine body 11, and a slider 12 slidable relative to the magazine body 11. A nail accommodating portion 16 for accommodating connected nails therein is formed between the magazine body 11 and the slider 12. A guide piece 17 for guiding distal end portions of shanks of the nails into an injection port is provided at the magazine body 11. A head guide member 21 for guiding heads of the nails is disposed so as to slide in a longitudinal direction of the magazine body 11. The head guide member 21 is slid relative to the magazine body 11 in accordance with a sliding movement of the slider 12 relative to the magazine body 11.

### TECHNICAL FIELD

This invention relates to a nailing machine in which a number of nails interconnected in parallel relation are loaded into a straight sheath-shape magazine connected to an injection port, and the connected nails are transferred forward within the magazine, and are sequentially supplied into the injection port, and the leading nail of the connected nails supplied into the injection port is struck out of the injection port by a driver driven to be slid in the injection port, and the invention also relates to the magazine for the nailing machine.

### BACKGROUND ART

In a power-driven nailing machine, there are used connected nails, in which shanks of a number of nails are arranged in parallel relation and are interconnected by an interconnecting strip. The connected nails loaded into a magazine are sequentially supplied to an injection port formed at a front side of the magazine. The nail supplied into the injection port is struck by a driver driven by power such as compressed air, and is driven into a work located at a front end of the injection port. An ordinary nail has a head of a larger diameter formed at one end thereof. However, particularly in a construction of an interior finishing material in a residential building, a process of manufacturing furniture, etc., finishing nails, each having no head of a larger diameter at its one end or having a head of a very small size, are used. When the finishing nails are used, the heads of the driven nails are not conspicuous at the surface of the work after the nailing operation. Such finishing nails are formed as linearly-connected nails in which shanks of any two adjacent nails are juxtaposed in intimately contacted relation, and an adhesive is coated between the shanks of these nails.

JP-A-09-109052 discloses a magazine of a nailing machine using such linearly-connected nails as described above. The magazine of JP-A-09-109052 is provided with a magazine body attached to a nose portion of the nailing machine, and a slider slidably supported on a side surface of this magazine body. A nail accommodating portion for accommodating the linearly-connected nails therein is formed between the magazine body and the slider. When the slider is slid rearward relative to the magazine body, the nail accommodating portion is opened, and also a pusher is moved rearward, so that the connected nails can be loaded into the nail accommodating portion. Metallic guide members exposed to the interior of the nail accommodating portion are provided at both of those surfaces of the magazine body and the slider forming the side surfaces of the nail accommodating portion, respectively. The connected nails are guided and supplied to an injection port of the nose portion by these guide members.

In the structure in which the connected nails are guided by the guide members provided at the magazine body and the slider as described above, the leading nail of the connected nails, in some cases, is caught by an inlet portion leading from the nail accommodating portion to the injection port of the nose portion because of a play due to a tolerance of the dimension between the magazine body and the slider, etc., so that the leading nail fails to be supplied into the injection port. To deal with this, in related art of the present application which is not prior art, a guide piece is formed at the magazine body, and this guide piece guides distal ends of the connected nails and the side surfaces of the distal end portions facing the slider. In this magazine, regardless of variations in the dimension between the magazine body and the slider, etc., the connected nails can be positively guided into the injection port by setting the dimension on the part of the magazine body.

In the magazine of the related art, with respect to nails of a maximum size to be loaded into the magazine, the distal ends of the connected nails are guided by the guide piece formed at the magazine, and head portions of the connected nails are guided by the slider. The tolerance of the dimension between the magazine body and the slider which are formed by extrusion of aluminum or the like is set to a larger value. Therefore, the dimensions for guiding the connected nails are not stable, and the connected nails may swing within the nail accommodating portion. As a result, when the leading nail supplied into the injection portion is to be struck by a driver, the distal end of the leading nail is, in some cases, inclined to be directed to the rear side of the injection port within the accommodating portion. When the nail is thus inclined with in the accommodating portion, the nail is, in some cases, buckled to be jammed in the injection port.

And besides, in the magazine of the above related art, the guide piece for guiding the distal end portions of the connected nails is formed integrally with the magazine body. Therefore, the connected nails are loaded into the nail accommodating portion of the magazine body along the inner surface of the magazine body from the upper side. As a result, in the case where a guide member for guiding the head portions of the connected nails is formed in a projecting manner at an upper portion of the nail accommodating portion, and extend in the longitudinal direction of the magazine body, the connected nails can not be loaded. Furthermore, in the case where the above guide member is shortened, and is formed near to the nose portion in order to maintain the operability concerning the loading of the connected nails, it can not sufficiently guide the connected nails, and can not prevent the connected nails from being inclined.

### DISCLOSURE OF THE INVENTION

One or more embodiments of the present invention provide a nailing machine and a magazine which have a nail guide function capable of positively guiding distal end portions and head portions of connected nails loaded in the magazine so that the connected nails will not be inclined within the magazine, without adversely affecting the capability of loading the connected nails.

In accordance with one or more embodiments of the present invention, a magazine of a nailing machine is provided with a magazine body; a slider slidable relative to the magazine body; a nail accommodating portion which is formed between opposed inner surfaces of the magazine body and the slider, and accommodates connected nails therein; a guide piece which guides distal end portions of shanks of the nails loaded in the nail accommodating portion, and a head guide member which is disposed so as to slide in a longitudinal direction of the magazine body, and guides heads of the nails loaded in the nail accommodating portion. The head guide member slides relative to the magazine body in accordance with a sliding movement of the slider relative to the magazine body.

In accordance with one or more embodiments of the present invention, the slider is made of an aluminum alloy or a synthetic resin, and the head guide member is made of a steel material.

In accordance with one or more embodiments of the present invention, the magazine for the nailing machine is further provided with a plurality of pushers for pressing and pushing the nails, loaded in the nail accommodating portion, forward. The plurality of pushers are provided at intervals in a direction of a length of a shank of each nail.

In accordance with one or more embodiments of the present invention, the plurality of pushers are pressed and pushed forward independently of one another respectively by a plurality of springs.

In accordance with one or more embodiments of the present invention, the plurality of pushers are provided at the slider, and a side edge of at least one of the plurality of pushers is received in a groove formed in the magazine body and extending in the longitudinal direction thereof.

In accordance with one or more embodiments of the present invention, when the slider slides toward a rear side of the magazine body, the plurality of pushers move rearward together with the slider, and when the slider slides toward a front side of the magazine body, front end edges of the plurality of pushers are engaged with the shank of the nail to press and push the nails.

In accordance with one or more embodiments of the present invention, when the slider slides forward, part of the plurality of pushers disposed above the heads of the nails loaded in the nail accommodating portion moves in the groove to a front end thereof, and is located above the nails to thereby limit the upward movement of the nails within the nail accommodating portion.

In accordance with one or more embodiments of the present invention, the magazine for the nailing machine is further provided with a guide groove formed in an upper portion of the magazine body and extending in the longitudinal direction thereof, and an engagement piece portion formed at an upper portion of the slider and engaged in the guide groove. The engagement piece portion is slid in the guide groove, thus enabling the slider to slide relative to the magazine body.

In accordance with one or more embodiments of the present invention, the magazine for the nailing machine further includes a notch formed in the engagement piece portion of the slider, and a projecting piece portion formed at the head guide member. The head guide member is slidably mounted in the guide groove, and the projecting piece portion is engaged in the notch.

In accordance with one or more embodiments of the present invention, the connected nails are formed by arranging shanks of a number of nails in a plane in intimately contacted relation to one another and by adhesively bonding any two adjacent shanks together by an adhesive to thereby interconnect the nails linearly.

According to one or more embodiments of the present invention, a nailing machine is provided with a housing accommodating a striking mechanism therein; a nose portion which is mounted at a lower side of the housing and has an injection port for guiding the driving of a nail toward a work; and a magazine which accommodates a number of connected nails therein, and supplies the connected nails to the injection port. In this nailing machine, the magazine is provided with a magazine body connected to and held by the nose portion at its front end portion; a slider slidable relative to the magazine body; a nail accommodating portion which is formed between opposed inner surfaces of the magazine body and the slider, and accommodates the connected nails therein; a guide piece which guides distal end portions of shanks of the nails, loaded in the nail accommodating portion, into the injection port; and a head guide member which is disposed so as to slide in a longitudinal direction of the magazine body, and guides heads of the nails loaded in the nail accommodating portion. The head guide member slides relative to the magazine body in accordance with a sliding movement of the slider relative to the magazine body.

In the invention, the magazine is structured by the magazine body connected to and held by the nose portion at its front end portion, and the slider held on the magazine body so as to slide relative to this magazine body. The nail accommodating portion for accommodating the connected nails is formed between the opposed inner surfaces of the magazine body and the slider, and the guide piece for guiding the distal end portions of the shanks of the nails, loaded in the nail accommodating portion, into the injection port is formed at the magazine body. Further, the head guide member for guiding the heads of the nails loaded in the nail accommodating portion is disposed so as to slide in the longitudinal direction of the magazine body, and the head guide member is slid relative to the magazine body in accordance with the sliding movement of the slider relative to the magazine body. Therefore, the head guide member can be formed as the part separate from the slider, and when this head guide member is made of metal having high wear resistance, the head guide member is prevented from being worn, or when its guide performance is lowered by wear, only the head guide member can be exchanged, and by doing so, high guide accuracy can be maintained for a long period of time. Furthermore, the head guide member 21 can be slidingly moved together with the slider toward the rear side of the magazine body, and therefore the connected nails can be easily loaded into the nail accommodating portion from the upper side thereof.

Other aspects and advantages of the invention will be apparent from the following description and the appended claims.

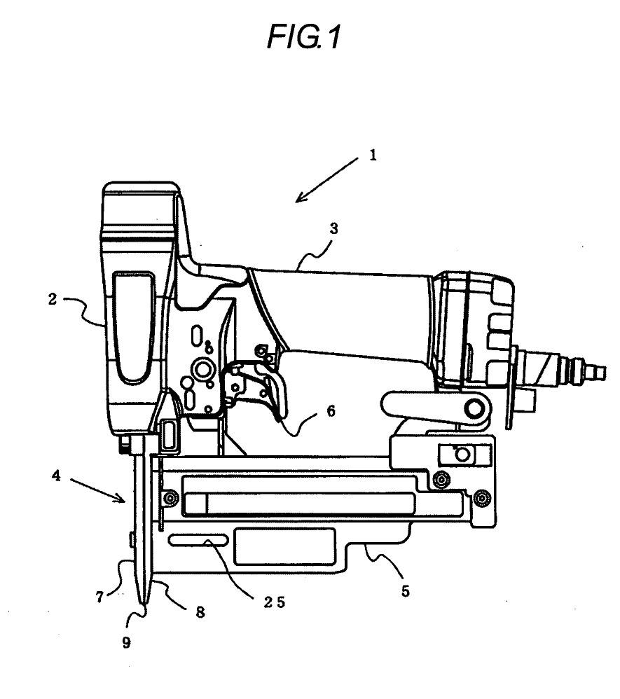

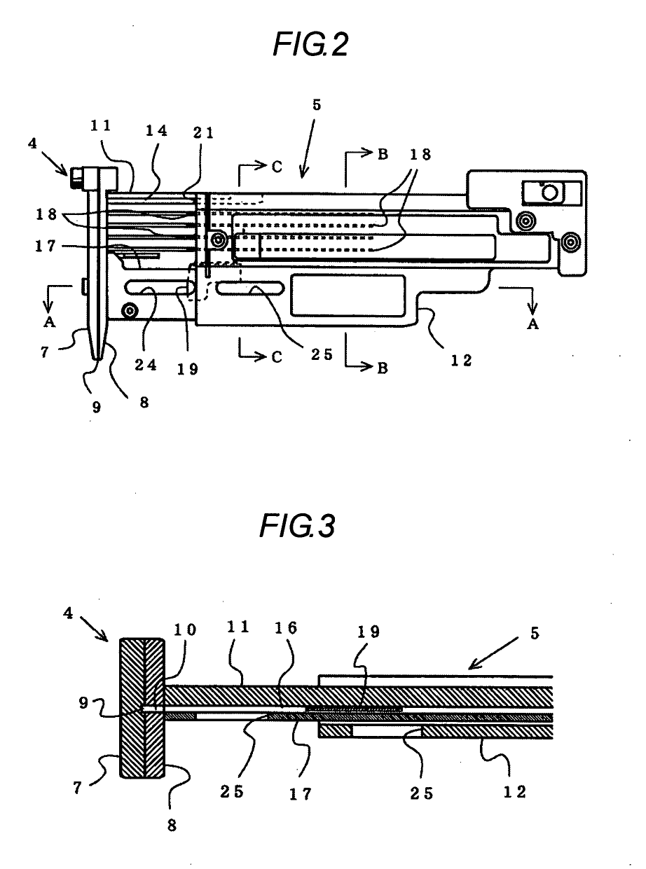

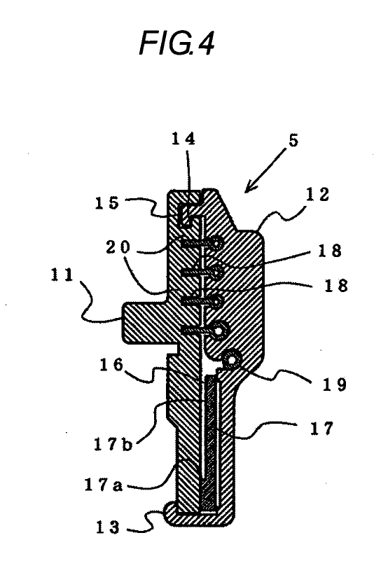

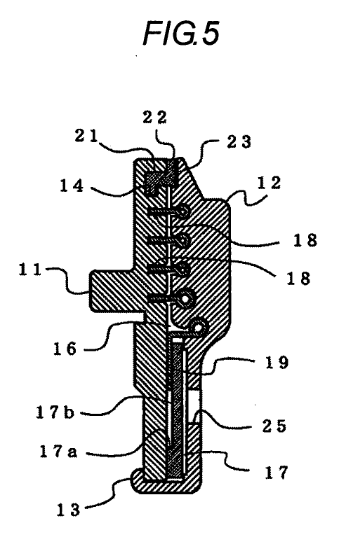

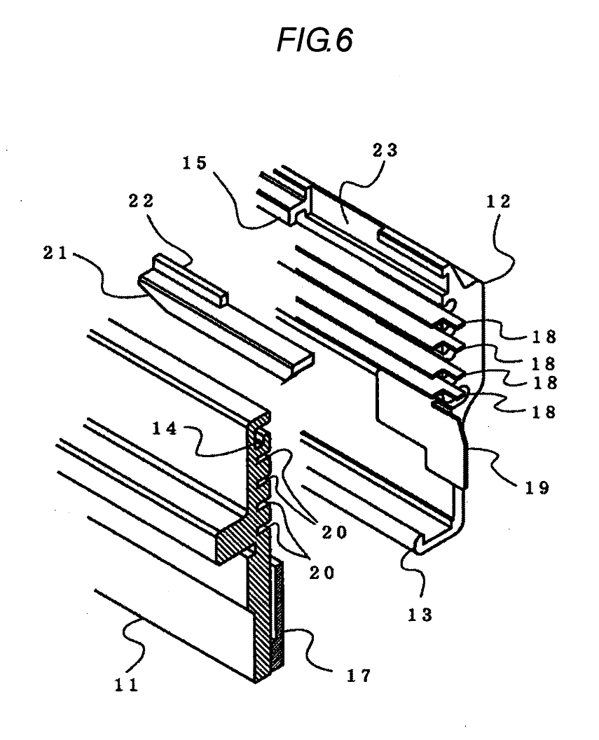

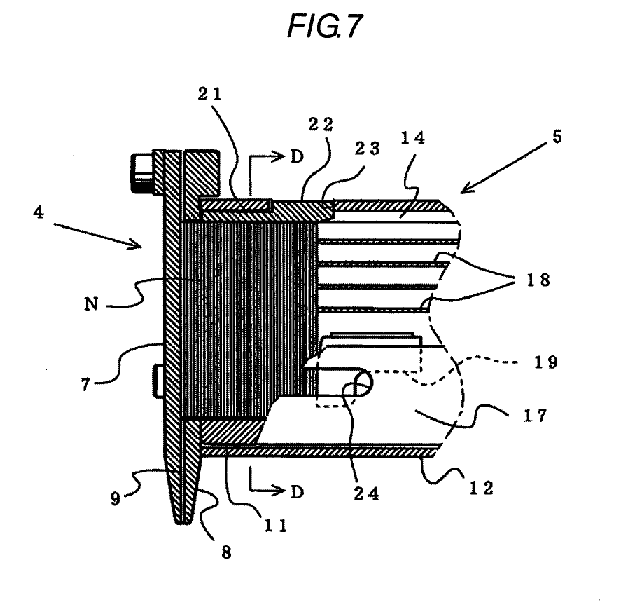

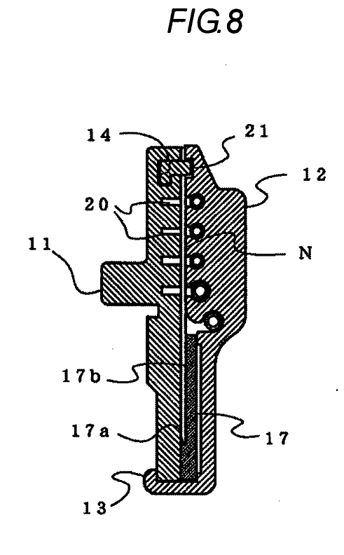

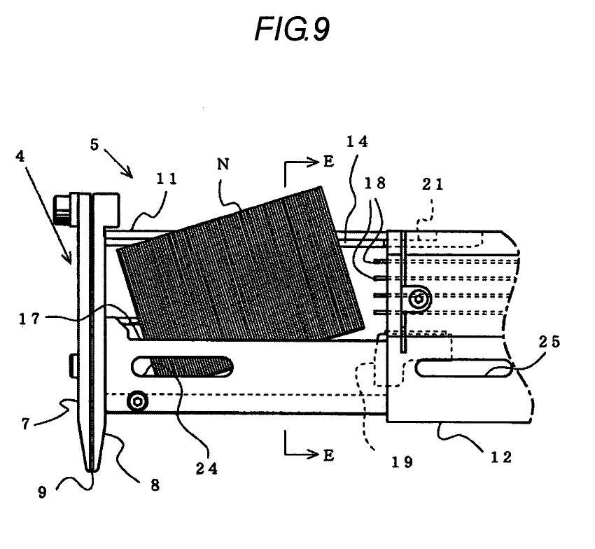

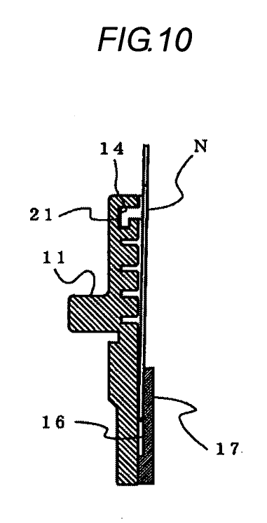

### BRIEF DESCRIPTION OF THE DRAWINGS

[FIG. 1] FIG. 1 is a side-elevational view of a nailing machine.

[FIG. 2] FIG. 2 is a side-elevational view of a magazine, showing a condition in which a slider is slightly moved rearward relative to a magazine body.

[FIG. 3] FIG. 3 is a cross-sectional view taken along the line A-A of FIG. 2.

[FIG. 4] FIG. 4 is a cross-sectional view taken along the line B-B of FIG. 2.

[FIG. 5] FIG. 5 is a cross-sectional view taken along the line C-C of FIG. 2.

[FIG. 6] FIG. 6 is an exploded perspective view showing the shapes of rear portions of the magazine body and a slider.

[FIG. 7] FIG. 7 is a vertical cross-sectional, side-elevational view of the magazine of FIG. 2 in which connected nails are loaded.

[FIG. 8] FIG. 8 is a cross-sectional view taken along the line D-D of FIG. 7.

[FIG. 9] FIG. 9 is a side-elevational view showing a condition in which the connected nails are in the process of being loaded into the magazine of FIG. 2.

[FIG. 10] FIG. 10 is a cross-sectional view taken along the line E-E of FIG. 9.

### DESCRIPTION OF THE REFERENCE NUMERALS

5 magazine

11 magazine body

12 slider

14 guide groove

16 nail accommodating portion

17 guide piece

21 head guide member

### BEST MODE FOR CARRYING OUT THE INVENTION

An embodiment of the present invention will now be described with reference to the drawings.

### FIRST EMBODIMENT

FIG. 1 shows a nailing machine using compressed air for a drive source as one example of nailing machines. The nailing machine 1 is structured by a housing 2 which accommodates a striking mechanism such as a piston-cylinder mechanism and has a rearwardly-extending grip portion 3 (for the grasping of the nailing machine 1) formed integrally therewith, a nose portion 4 which is mounted on the lower side of the housing 2 and has an injection port for guiding the driving of a nail toward a work which is to be nailed, and a magazine 5 which accommodates a number of nails therein and is supported by a rear end of the grip portion 3 and the nose portion 4. The nails accommodated within the magazine 5 are sequentially supplied into the injection port formed in the nose portion 4, and when a trigger lever 6 formed at the lower side of a proximal end portion of the grip portion 3 is operated, the striking mechanism is driven to drive the nail (supplied to the injection port) out of the injection port toward the work located at the distal end of the nose portion 4.

As shown in FIGS. 2 and 3, the nose portion 4 is provided with a driver guide 7 mounted on the lower end of the housing 2, and a wear plate 8 mounted on the rear side of the driver guide 7 in intimately contacted relation thereto, and the injection port 9 for guiding the driving of the nail toward the work is formed between the driver guide and the wear plate. The nails used in the nailing machine 1 are finishing nails each having no head of a larger diameter formed at one end thereof, and are formed as linearly-connected nails in which shanks of a number of nails are arranged in a plane in intimately contacted relation to one another, and any two adjacent shanks are adhesively bonded together by an adhesive. An opening 10 is formed in the wear plate 8, and the connected nails are supplied into the injection port 9 through this opening 10 from the rear side of the wear plate 8.

The magazine 5 is provided with a magazine body 11 which is mounted at its front end portion on the rear surface of the wear plate 8 and is supported at its rear end portion by the rear portion of the grip portion 3, and a slider supported on the magazine body 11 so as to slide relative to this magazine body in a direction of supply of the nails. As shown in FIG. 4, a hook portion 13 is formed at a lower end of the slider 12, and is engaged with a lower end edge of the magazine body 11 in an embracing manner. Further, an engagement piece portion 15 is formed at an upper end portion of the slider 12, and is engaged in a guide groove 14 formed in an upper end portion of the magazine body 11 and extending in the longitudinal direction thereof. The hook portion 13 and the engagement piece portion 15 are engaged respectively with the lower end edge and guide groove 14 of the magazine body, and by doing so, the slider 12 is supported on the magazine body 11 so as to slide relative to the magazine body in the longitudinal direction.

A nail accommodating portion 16 for accommodating the connected nails therein is formed between opposed surfaces of the magazine body 11 and the slider 12. When the slider 12 is slidingly moved rearward relative to the magazine body 11, the inner surface of the magazine body 11 forming the nail accommodating portion 16 is opened so that the connected nails can be loaded along the inner surface of the magazine body 11. A front end of the nail accommodating portion 16 is continuous with the opening 10 formed in the wear plate 8, and the connected nails can be guided into the injection port 9 by the nail accommodating portion 16.

A guide piece 17 is formed at the inner surface of the magazine body 11 forming the nail accommodating portion 16, and this guide piece 17 supports distal ends of the shanks of the connected nails accommodated within the nail accommodating portion 16, and guides those side surfaces of the connected nails, facing the slider 12, toward the opening 1O. An engagement surface 17afor supporting the distal ends of the shanks of the connected nails accommodating within the nail accommodating portion 16 is formed at the guide piece 17, and also a guide surface 17bis formed at the guide piece 17, and is spaced from the inner surface of the magazine body 11 by such a distance that the shanks of the nails can be received therebetween. By the engagement surface 17aand the guide surface 17b, the connected nails are guided to the opening 10 formed in the wear plate 18, and the connected nails are guided into the injection port 9, formed in the nose portion 4, through the opening 10.

A plurality of pushers 18 and 19 are provided at the slider 12, and are spaced from one another in the length of each nail shank, and these pushers engage the trailing nail of the connected nails loaded in the nail accommodating portion 16, and press and push the connected nails toward the nose portion 4 to supply the leading nail of the connected nails into the injection port 9 formed in the nose portion 4. The pushers 18 and 19 are pressed and urged forward independently of one another by respective springs (not shown) acting thereon. The lowermost pusher 19 among the plurality of pushers is so disposed as to engage a shank of a trailing one of the shortest connected nails loaded in the nail accommodating portion 16 to press and supply these connected nails forward. The other pushers 18 are so arranged as to be disposed above heads of nails of various sizes loaded in the nail accommodating portion 16. When the slider 12 is slid toward the rear side of the magazine body 11, the pushers 18 and 19 are moved rearward together with the slider 12. At the time when the slider 12 is slid toward the front side of the magazine body 11 after the connected nails are loaded into the nail accommodating portion 16, front end edges of the pushers 18 and 19 are engaged with the shank of the trailing nail of the connected nails to press and supply the connected nails toward the front side of the magazine 5.

A plurality of grooves 20 which respectively receive side edges of the pushers 18 (except the lowermost pusher 19) projecting toward the magazine body 11 are formed in the magazine body 11 in opposed relation to the respective pushers 18, and extend in the longitudinal direction of the magazine body 11. The pushers 18 and 19 disposed below the heads of the nails loaded in the nail accommodating portion 16 are engaged with the rear end of the series of connected nails as described above to press and supply the connected nails forward by the springs acting respectively on these pushers 18 and 19. However, when short connected nails are accommodated in the nail accommodating portion 16, the pusher (or pushers) 18 located at a level above heads of these connected nails moves forward in the groove 20 in accordance with the forward sliding movement of the slider 12, and is located above the heads of the connected nails, thereby limiting the swinging movement of the nails within the nail accommodating portion 16.

As shown in FIGS. 5 and 6, the guide groove 14 (in which the engagement piece portion 15 formed at the slider 12 is slidably engaged) is formed in the surface of the upper portion of the magazine body 11 opposed to the slider 12. Ahead guided member 21 for guiding heads of connected nails of the largest size loaded in the nail accommodating portion 16 is loosely fitted in the guide groove 14, and is held so as to slide in the longitudinal direction of the magazine body 11. A projecting piece portion 22 formed integrally with this head guide member 21 is engaged in a notch 23 formed in the engagement piece portion 15 of the slider 12, and when the slider 12 is slid relative to the magazine body 11, the head guide member 21 is moved together with the slider 12 in the longitudinal direction of the magazine body 11. When the slider 12 is located at the position of the front end of the magazine body 11, the distal end portions of the shanks of those of the connected nails (loaded in the nail accommodating portion 16) disposed near to the injection port 9 of the nose portion 4 are guided by the guide piece 17, while the head portions thereof are guided by the head guide member 21.

When the slider 12 is moved to the position of the front end of the magazine body 11 as shown in FIGS. 7 and 8, the forward and rearward movements of the head guide member 21 are limited by the wear plate 8 (mounted at the front end of the magazine body 11) and the slider 12, and also the upward and downward movements of the head guide member 21 are determined by a fit tolerance for the guide groove 14 and the head guide member 21. Therefore, the dimensions for guiding the shank distal end portions and head portions of the connected nails N within the nail accommodating portion 16 in the vicinity of the injection port 9 can be controlled by setting the dimensions only on the part of the magazine body 11, and regardless of a dimensional tolerance for the magazine body 11 and the slider 12 slidably supported on this magazine body 11, the connected nails N can be guided within the nail accommodating portion 16 without being inclined.

Furthermore, when the slider 12 is slid toward the rear side of the magazine body 11 in order to load the connected nails N into the nail accommodating portion 16, the head guide member 21 engaged in the notch 23 formed in the slider 12 is moved toward the rear side of the magazine body 11 together with the slider 12, so that the upper side of the inner surface of the magazine body 11 forming the nail accommodating portion 16 is opened, and therefore the linear connected nails N can be loaded into the nail accommodating portion 16 between the inner surface of the magazine body 11 and the guide piece 17 from the upper side.

As described above, the head guide member 21 for guiding the head portions of the connected nails N is formed as one part separate from the slider 12, and the head guide member 21 is slidably supported in the guide groove 14 of the magazine body 1. Therefore, when this head guide member 21 is made of metal having high wear resistance, the head guide member 21 is prevented from being worn by contact with the nails, or only the head guide member 21 can be exchanged when its guide performance is lowered by wear. Furthermore, the head guide member 21 is engaged with the slider 12, and can be slidingly moved together with the slider 12 toward the rear side of the magazine body 11, and therefore the connected nails N can be positively guided into the injection port 9 by the guide piece 17 formed at the magazine body 11, and also the connected nails N can be easily loaded into the nail accommodating portion 16 from the upper side thereof.

The head guide member 21 has high wear resistance, and therefore it is preferably made of a steel material. Similarly, the guide piece 17 has high wear resistance, and therefore it is preferably made of a steel material. On the other hand, the magazine body 11 required to have rigidity is preferably made of a steel material or an aluminum alloy. From the viewpoint of a lightweight design, it is more preferred that the magazine body 11 be made of an aluminum alloy. From the viewpoint of a lightweight design, the slider 12 is preferably made of an aluminum alloy or a synthetic resin. When the slider 12 is made of a synthetic resin, the more lightweight design can be achieved as compared with the case of using an aluminum alloy.

In the drawings, reference numerals 24 and 25 denote windows which are formed respectively in the guide piece 17 and the slider 12 so that the conditions (the number of remaining nails, etc.) of the connected nails N loaded in the nail accommodating portion 16 of the magazine 5 can be confirmed from the exterior. When the slider 12 is moved to the position of the front end of the magazine body 11, the two windows 24 and 25 are disposed in registry with each other, and the remaining condition of the connected nails N within the nail accommodating portion 16 or the position of the pusher 19, etc., can be viewed with the eyes.

In the above embodiment, although the magazine, using the finishing nails each having no head of a larger diameter formed at one end thereof, has been described, the invention can also be applied similarly to a magazine which can be loaded with connected nails which have laterally projecting heads formed at their respective one ends, and are interconnected into a linear form with their shanks held in intimate contact with one another. Furthermore, in the above embodiment, although the compressed air-driven nailing machine which is driven by compressed air has been described, the invention is not limited to this, and can be applied to a power-driven nailing machine driven by an electric motor or combustion gas pressure.

Although the details and specific embodiment of the present invention have been described above, it is apparent to those skilled in the art that various changes and modifications can be added without departing from the spirits and scope of the invention.

The present application is based on Japanese Patent Application (Japanese Patent Application No. 2004-313823) filed on Oct. 28, 2004, and contents of which are hereby incorporated by reference.

### INDUSTRIAL APPLICABILITY

The distal end portions and head portions of the connected nails loaded in the magazine are positively guided so that the connected nails will not be inclined within the magazine, without adversely affecting the capability of loading the connected nails.

1. A magazine of a nailing machine comprising:
a magazine body;
a slider slidable relative to the magazine body;
a nail accommodating portion that is formed between opposed inner surfaces of the magazine body and the slider and accommodates connected nails therein; and
a head guide member that is disposed slidably in a longitudinal direction of the magazine body, and guides heads of the nails loaded in the nail accommodating portion;
wherein the head guide member slides relative to the magazine body in accordance with a sliding movement of the slider relative to the magazine body.

2. The magazine of a nailing machine according to claim 1, wherein the slider is made of one of a synthetic resin and an aluminum alloy, and
the head guide member is made of a steel material.

3. The magazine of a nailing machine according to claim 1, further comprising a plurality of pushers for pressing and pushing forward the nails loaded in the nail accommodating portion,
wherein the plurality of pushers are provided along a direction of a length of a shank of each nail.

4. The magazine of a nailing machine according to claim 3, wherein the plurality of pushers are pressed and pushed forward independently of one another respectively by a plurality of springs.

5. The magazine of a nailing machine according to claim 4, wherein the plurality of pushers are provided at the slider, and
a side edge of at least one of the plurality of pushers is received in a groove formed in the magazine body and extending in the longitudinal direction of the magazine body.

6. The magazine of a nailing machine according to claim 5, when the slider slides toward a rear side of the magazine body, the plurality of pushers move rearward together with the slider; and
when the slider slides toward a front side of the magazine body, front end edges of the plurality of pushers are engaged with the shank of the nail to press and push the nails.

7. The magazine of a nailing machine according to claim 6, when the slider slides forward, a part of the plurality of pushers disposed above the heads of the nails loaded in the nail accommodating portion moves in the groove to a front end thereof, and is located above the nails to thereby limit the upward movement of the nails within the nail accommodating portion.

8. The magazine of a nailing machine according to claim 1, further comprising:
a guide groove formed in an upper portion of the magazine body and extending in the longitudinal direction of the magazine body; and
an engagement piece portion formed at an upper portion of the slider and engaged in the guide groove,
wherein the slider slides relative to the magazine body by sliding the engagement piece portion in the guide groove.

9. The magazine of a nailing machine according to claim 8, further comprising:
a notch formed in the engagement piece portion of the slider; and
a projecting piece portion formed at the head guide member,
wherein the head guide member is slidably mounted in the guide groove; and
the projecting piece portion is engaged in the notch.

10. The magazine of a nailing machine according to claim 1, wherein the connected nails are formed by arranging shanks of a number of nails in a plane in intimately contacted relation to one another, and by adhesively bonding any two adjacent shanks together by an adhesive to thereby interconnect the nails linearly.

11. The magazine of a nailing machine according to claim 1, further comprising a guide piece that guides distal end portions of shanks of the nails loaded in the nail accommodating portion.

12. A nailing machine comprising:
a housing accommodating a striking mechanism therein;
a nose portion that is mounted at a lower side of the housing and includes an injection port for guiding a driving of a nail toward a work; and
a magazine that accommodates a number of connected nails therein, and supplies the connected nails to the injection port;
wherein the magazine comprises:
a magazine body connected to and held by the nose portion at its front end portion;
a slider slidable relative to the magazine body;
a nail accommodating portion that is formed between opposed inner surfaces of the magazine body and the slider, and accommodates the connected nails therein;
a guide piece that guides distal end portions of shanks of the nails loaded in the nail accommodating portion toward the injection port; and
a head guide member that is disposed slidably in a longitudinal direction of the magazine body and guides heads of the nails loaded in the nail accommodating portion, and
wherein the head guide member slides relative to the magazine body in accordance with a sliding movement of the slider relative to the magazine body.
